(19) United States
(12) Patent Application Publication
(10) Pub. No.: US 2012/0220438 A1
(43) Pub. Date: Aug. 30, 2012

(54) Filter Rod Maker

(75) Inventors: Arnold Leslie Herholdt, Brackenfell (ZA); Gerhard Malan Le Roux, Paarl (ZA)

(73) Assignee: Tobacco Research and Development Institute (Proprietary) Limited, Stellenbosch (ZA)

(21) Appl. No.: 13/393,209

(22) PCT Filed: Aug. 19, 2010
(86) PCT No.: PCT/IB2010/053746

§ 371 Date: May 14, 2012

(30) Foreign Application Priority Data
Aug. 28, 2009 (ZA) 2009/05994

(51) Int. Cl. B31C 99/00

(52) U.S. Cl. 493/39

(57) ABSTRACT

A machine for making filter rods for use in the manufacture of smoking articles comprises a garniture configured to receive filter plug material and filter wrapping material and to form a wrapped elongate filter rod, the garniture comprising a tongue; the maker further comprises a rotatable object-transport member arranged to receive objects from an object store and to deliver said objects directly into the tongue such that the objects are inserted into filter plug material passing through the tongue and a cutter configured to cut the elongate filter rod, thereby forming filter rod segments having one or more objects therein.

### FIELD OF THE INVENTION

This invention relates to a machine for making filter rods for use in the manufacture of smoking articles such as filtered cigarettes. The machine is configured to insert objects into the filter rods.

### BACKGROUND OF THE INVENTION

Filter rods used in the manufacture of filtered cigarettes conventionally comprise a plug of cellulose acetate tow wrapped with a paper plugwrap. Known filter rod making machines comprise a garniture which receives a flow of tow and a ribbon of filter paper and forms a paper wrapped elongate filter rod, which is subsequently cut into filter rod segments. The garniture usually has a tongue which compresses the filter tow as it passes therethrough. This type of filter making machine and in particular the garniture and tongue elements are well known per se to those skilled in the art.

EP1833316 describes a machine configured to provide filter media, in particular granular material or pre-measured capsules, into filter material during filter rod manufacture. The machine of EP1833316 has a suction dome which sucks filter media into a plurality of spaced apart pockets formed in the circular face of a rotating pocket wheel. Rotation of the pocket wheel positions the pockets filled with filter media in register with the inlet of an air transport tube. Once aligned, vacuum is released and air pressure applied through a perforated pocket “bottom” to expel the media into the transport tube. The tube is arranged to enter the tongue of the machine so that when the filter media exits the discharge end of the tube it passes into the centre of the filter rod being formed. Subsequently, the rod is wrapped with paper.

### SUMMARY OF THE INVENTION

The present invention provides an alternative approach to inserting objects into filter rod material during filter rod manufacture.

The invention provides a machine for making filter rods for use in the manufacture of smoking articles, comprising a garniture configured to receive filter plug material and filter wrapping material and to form a wrapped elongate filter rod, the garniture comprising a tongue configured so that filter plug material is compressed as it passes therethrough; the filter maker further comprises a rotatable object-transport member arranged to receive objects from an object store and to deliver said objects directly into the tongue such that the objects are inserted into filter plug material passing through the tongue, and a cutter configured to cut the elongate filter rod, thereby forming filter rod segments having one or more objects therein.

In this way, the objects are delivered into the tongue of the garniture directly, without intermediary. Thus mechanical complexity of the maker is minimised.

Further, the filter plug material follows a steady, controlled path through the tongue and thereafter and thus the position and/or spacing of the objects in the eventual rod can be precisely controlled by placing the objects in appropriate positions of the filter plug material passing through the tongue.

Preferably, the filter plug material undergoes compression in the tongue such that the filter plug material presses against the objects so as to secure them in position in the filter plug material passing through the tongue. In this way, unwanted positional variation from object to object is minimised.

Preferably, the filter plug material is cellulose acetate tow.

Preferably, the objects are inserted into the tow in the tongue such that the objects in the wrapped elongate filter rod are evenly spaced. Further preferably, the objects are inserted into the tow in the tongue such that the one or more objects are axially centred within the eventual filter rods.

The objects are preferably frangible fluid-containing capsules, but other objects such as pellets, strands, beads or any combination of pellets, strands, beads and capsules may alternatively or in addition be inserted. The capsule diameter is preferably within the range 2-6 mm.

The rotatable object-transport member preferably penetrates into the tongue such that each object received by the rotatable object transfer member exits the object-transport member at an exit point inside the tongue.

The rotatable object-transport member is preferably a rotatable wheel having a plurality of recesses arranged around the rim thereof.

Preferably the machine has a stuffer jet configured to compress the tow before it enters the garniture. Advantageously, the stuffer jet allows a more uniform density of tow to be achieved and enables manufacture of filters with different densities/pressure drops.

The machine may have a first body part comprising a first tongue part and a second body part comprising the object-transport member and a second tongue part, and a hinge arranged so that the relative position of the first and second body parts can be adjusted between a first position in which the first and second tongue parts are separated so that the interior of the tongue is accessible for cleaning and tow threading and a second position in which the first and second tongue parts are aligned so that tow can pass from one to the other.

In order that the invention may be more fully understood embodiments thereof will now be described by way of example with reference to the accompanying drawings in which:

### BRIEF DESCRIPTION OF THE DRAWINGS

FIG. 1 is a cross sectional view of a filter rod making machine.

FIG. 2 is a perspective view of the machine in its operative (in use) position.

FIG. 3 is a perspective view of the machine in a position in which the upper body of the machine is raised relative to the lower body.

FIG. 4 is a perspective view of the upper body and shows an exploded view of the inlet tongue section.

FIG. 5 shows the inlet tongue section.

FIG. 6 is a cross sectional view showing the capsule transport wheel positioned in the inlet tongue section.

FIG. 7 is a perspective view of a part of the lower body of the machine.

FIG. 8 is an exploded perspective of the view of FIG. 7.

FIG. 9 shows the plough of the inlet tongue section.

FIG. 10 shows filter rods.

FIG. 11 shows alternative ploughs.

FIG. 12 shows an alternative transport wheel.

FIG. 13 shows the stuffer jet of the machine.

### DETAILED DESCRIPTION

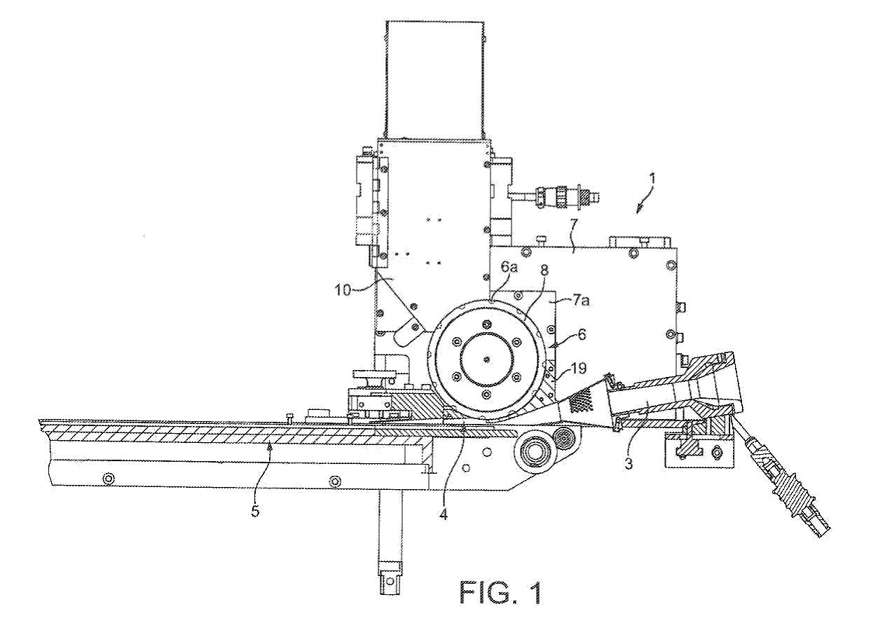

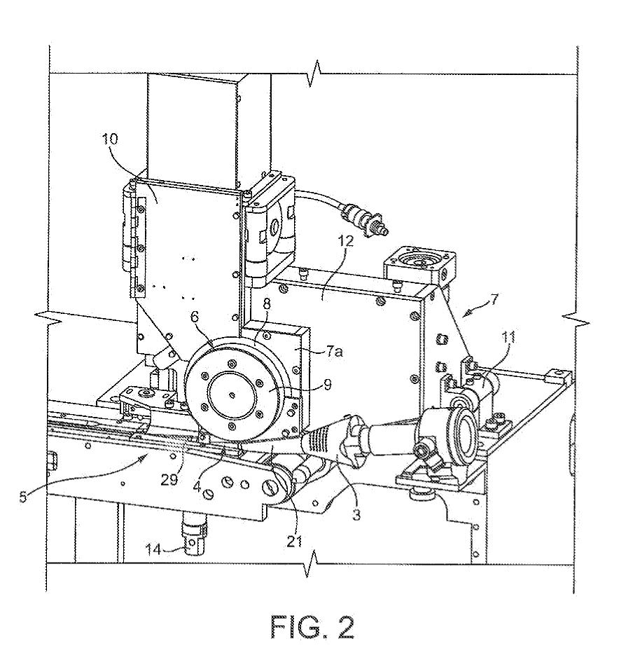

FIGS. 1 and 2 show part of a filter rod making machine 1. In operation, filter plug material in the form of cellulose acetate filter tow is drawn from a source, stretched in a set of stretching rollers (not shown) and compressed through stuffer jet 3 and through the tongue 4 of garniture 5. As shown, the machine 1 has a rotatable capsule transport wheel 6 arranged to deliver frangible flavourant-containing capsules from circumferential recesses 6a directly into the tongue so that the capsules come into contact with filter tow passing therethrough. The tow is paper wrapped in the garniture to form an elongate rod which is then cut to form filter rod segments, each of which contains a desired number of capsules, for example one, two, three or four.

The filter rod segments can be subsequently used in cigarette manufacture to make cigarettes having one or more capsules in the cigarette filter. In one exemplary cigarette manufacturing process, a filter rod segment containing two capsules is axially aligned with two paper wrapped tobacco rods positioned at opposing ends of the filter rod. A wrapper, known as a tipping paper, is then wrapped around the tobacco rods and filter rod to join them together. The wrapped filter rod is then transversely cut through its centre, between the two capsules, thereby forming a pair of filtered cigarettes, each having a capsule in its filter.

Each frangible capsule is preferably substantially spherical, formed from gelatin and contains a flavourant, for example menthol, spearmint, orange essence, mint, liquorice, eucalyptus, one or more of a variety of fruit flavours or any mixture of flavourants. By applying pressure to the outside of the filter the capsule can be ruptured, thereby releasing the flavourant, which acts to flavour the smoke drawn through the filter of the cigarette.

Turning now to a more detailed description of the machine 1, as shown in FIGS. 1 and 2, the transport wheel 6 is vertically orientated and rotatably mounted to the body 7 of the machine 1 on a shaft. The wheel 6 has a disk section 8 and a front section 9 bolted to the disk section 6. The disk section 8 is arranged between a capsule hopper 10 and the tongue 4 and is configured to sequentially transfer capsules therebetween.

The tongue 4 of the garniture 5 is tapered along its length so as to radially compress the filter tow as it passes through the tongue 4. Tow compression in the tongue is the final tow compression stage of the rod making process.

An opening is formed in the top of the tongue 4, the opening being wide enough to receive the disk section 8 of the transport wheel 6, which penetrates into the tongue 4 through the opening as shown in FIG. 1.

As the wheel 6 rotates, capsules fall under gravity from the hopper 10 into the plurality of capsule-receiving recesses 6a arranged circumferentially around the rim of the disk section 8, as shown in FIG. 1. The clockwise rotating wheel 6 carries the capsules through the opening in the top of the tongue and into the tongue interior, where the capsules exit the wheel 6 and pass into the filter rod being formed. As shown in FIG. 2, housing 7a is provided around the rim of disk section 8 to prevent capsules from falling from the wheel 6.

Thus, the capsules are delivered directly into the tongue of the garniture, where the path of the tow is steady and controlled, remaining so until the rod is formed.

Furthermore, since the capsules are inserted during compression of the tow, the tow is compressed around the capsules and thus secures them in position. Accordingly, the position and spacing of the objects in the eventual rod depends only on the position that the objects are placed in the tow passing through the tongue. Thus, the present machine allows the position of the capsules to be precisely controlled, with little variation from capsule to capsule or from filter to filter. This is desirable because consumers may perceive variations in capsule position negatively and may for example consider filters having off-centre capsules to be defective. Preferably, the capsules are positioned in the tow so as to be axially aligned and centered within the eventual rod.

The capsules exiting the wheel 6 may drop under gravity from the recesses 6a of the wheel 6 into the tow passing through the tongue 4. Alternatively, the transport wheel 6 may have a capsule ejection mechanism, for example an air-jet propulsion mechanism, configured to sequentially eject the capsules from the recesses in the rim section 8 and into the tow passing through the tongue 4. The transport wheel may alternatively, or in addition comprise a suction pump configured to apply suction to the capsules to hold them in position in the recesses before ejection.

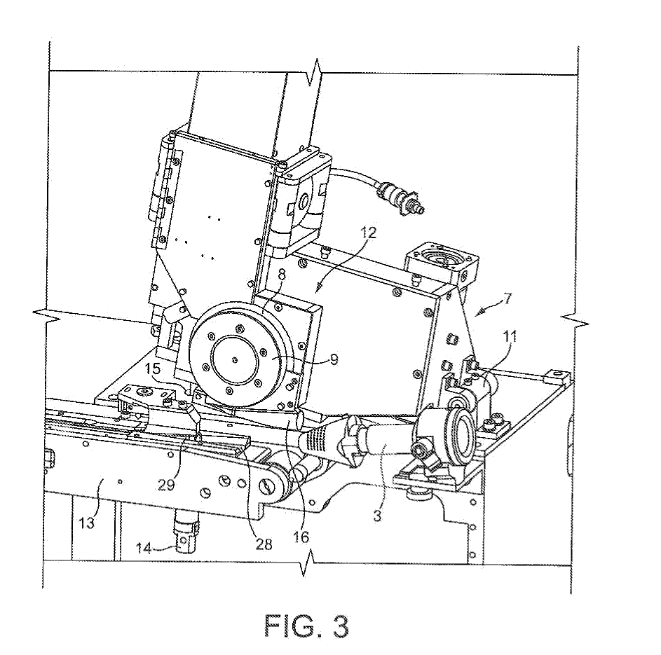

As shown in FIGS. 2 and 3, the machine 1 has a hinge mechanism which allows part of the tongue 4 to be lifted away from the machine 1. This facilitates threading of the tow from the stuffer jet 3 through the tongue 4 prior to machine start-up, and also allows convenient cleaning of the interior of the tongue 4.

The hinge mechanism comprises a hinge 11 connected to upper body 12 and lower body 13 of the machine 1, and a lifting cylinder 14 passing through a bore 15 in the lower body and attached to the bottom of the distal end of the upper body 12.

The hinge 11 is arranged so that upper body 12 of machine 1 can pivot upwards with respect to lower body 13 from the operative position shown in FIG. 2 to the lifted position shown in FIG. 3, and vice versa. In the operative position the upper body 12 rests on the lower body 13 and the outlet of the stuffer jet 3 is in register with the tongue entrance 4 as shown in FIG. 2. In the lifted position shown in FIG. 3 an inlet portion 16 of the tongue is positioned clear of the stuffer jet so that an operator can access the tongue interior for convenient cleaning and tow threading. The machine can be selectively positioned in either position by raising or lowering the lifting cylinder 14, which is preferably hydraulically actuated.

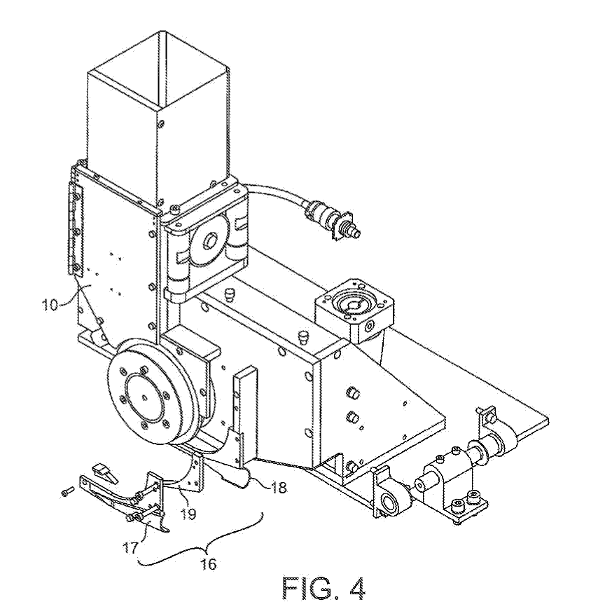

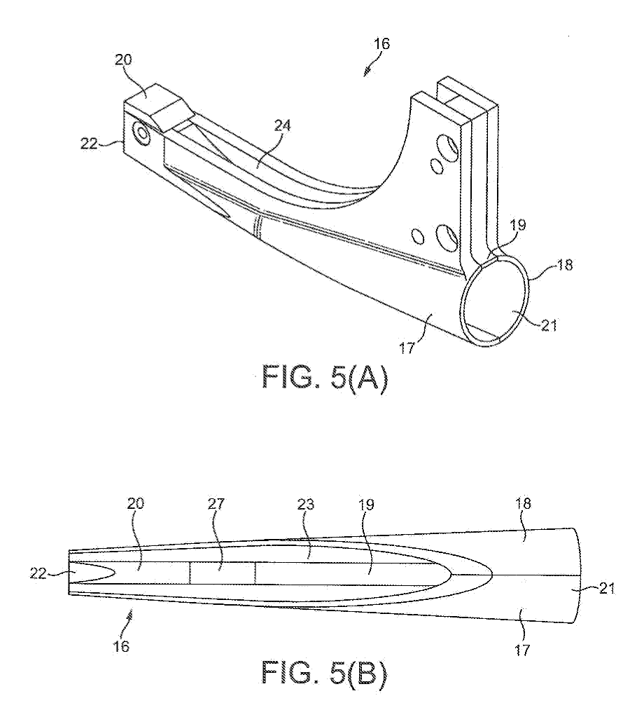

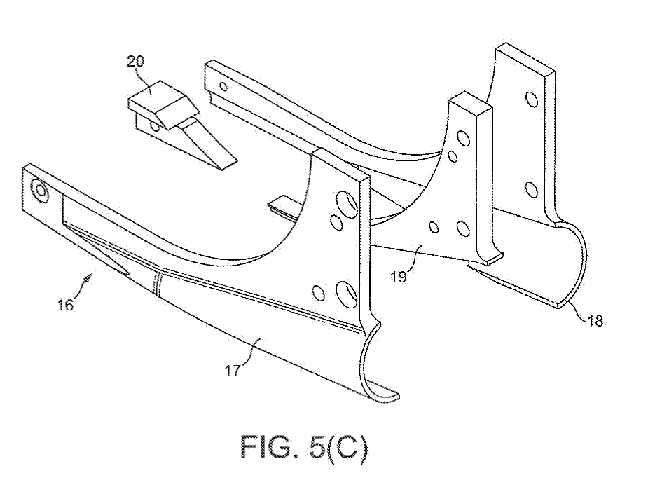

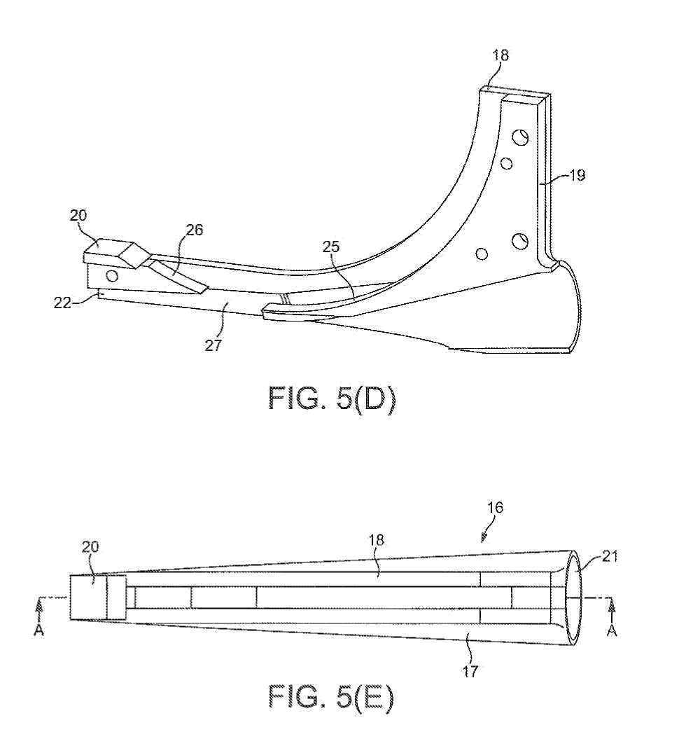

Referring to FIG. 4, upper body 12 comprises hopper 10, transport wheel 6 and inlet tongue portion 16, which is shown in exploded perspective view. As shown in FIGS. 4, 5 and 6, inlet tongue portion 16 comprises left and right sidewalls 17, 18, a plough 19 and a shoe 20. The plough 19 and shoe 20 are positioned at opposite ends of the inlet tongue portion 16 and between the sidewalls 17, 18, with a gap between the shoe 20 and plough 19. As shown, sidewalls 17 and 18 and plough 19 have extending upwardly attachment parts that have threaded holes in register with one another through which a set of bolts is threaded to hold the sidewalls 17, 18 and plough 19 together at one end of the inlet tongue portion 16. As shown in FIG. 5 the shoe 20 is bolted between and to the sidewalls 17, 18 at the opposing end of the tongue portion 16. As shown, the sidewalls 17, 18 and plough 19 define an inlet tube 21 at the input end of the inlet tongue portion 16, through which tow enters the tongue 4, and an outlet 22 through which tow exits the inlet tongue portion 16. Referring to FIG. 5(b), which shows a bottom view, the bottom of the inlet tongue portion 16 has an elongate opening 23 extending from the outlet 22 along the bottom of the inlet tongue portion 16 to the inlet tube 21.

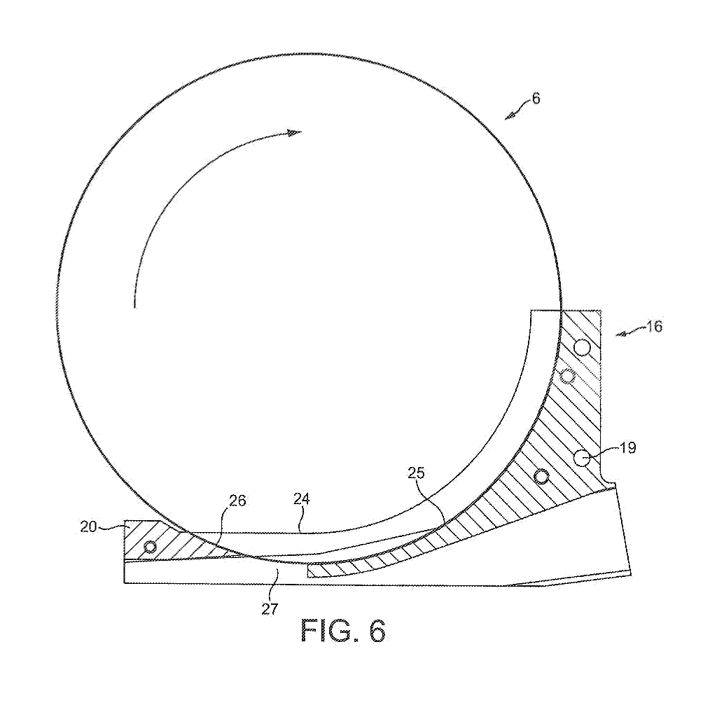

As shown in FIG. 5(a), left and right sidewalls 17, 18 define an opening 24 in the top of inlet tongue portion 16 into which the wheel 6 penetrates, as shown in FIG. 6. As shown, the plough 19 and shoe 20 have arcuate surfaces 25, 26 facing the wheel 6 and arranged so that in operation, the wheel 6 rotates in close proximity to the surfaces 25 and 26. The surface 25 of the plough 19 prevents capsules from unintentionally falling from the clockwise rotating wheel 6 while the surface 26 of the shoe acts to scrape off any tow which becomes attached to the wheel 6 so as to prevent tow from being carried by the wheel out of the opening 24. As shown in

FIG. 5(d), a gap 27 is defined between the bottom end of surface 25 and the bottom end of surface 26, and the bottom end of surface 25 is lower than the bottom end of surface 26.

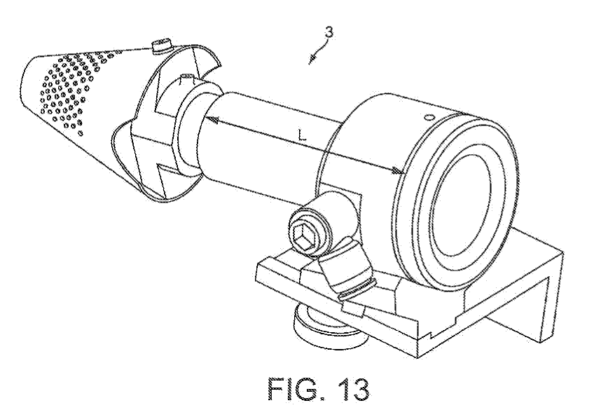

As shown in FIGS. 2 and 3, stuffer jet 3 (which can also be referred to as a “transport jet”) is mounted to the lower body 13 and is arranged to deliver tow directly into the inlet tube 21 of the tongue 4. Advantageously, the stuffer jet 3 allows a more uniform density of tow to be achieved in the eventual filters and enables filter manufacture with selected densities/pressure drops. The stuffer jet 3 is shown in more detail in FIG. 13. The length L of the body of the stuffer jet is preferably between 100 mm and 120 mm is further preferably 107.5 mm.

As shown in FIGS. 3, 7 and 8, lower body 13 has a garniture inlet channel 28 which tapers from the upstream to the downstream end thereof. In operation, the garniture tape runs along the floor of the channel 28 and a ribbon of plugwrap paper in frictional contact with the garniture tape is dragged through the channel 28 on top of the tape and is thereby drawn from a bobbin (not shown) along a series of rollers and into the garniture. The feature of a garniture tape in the garniture to progressively wrap plugwrap paper around the filter tow to form a filter rod is well known per se in the art and will not be described in detail herein.

As shown in FIGS. 2 and 3 the inlet tongue portion 16 is adapted to fit into and cover the channel 28 in the operative position shown in FIG. 2. In operation, tow passes through the inlet tube 21 and onto the moving paper ribbon in the channel 28 via the elongate opening 23 in the bottom of the inlet tongue portion 16. The tow is then dragged along the channel 28 by frictional contact with the paper ribbon.

Referring to FIG. 3, tongue 4 further comprises a fixed tongue portion 29 positioned just downstream of the inlet tongue portion 16. In use, tow in the channel 28 passes from through the outlet 22 of the inlet tongue portion 16 directly into the fixed tongue section 29. As shown, the inlet and fixed tongue sections 16, 29 are both tapered so that a continuous tapering is obtained along the length of the tongue 4 to compress the tow as it passes through.

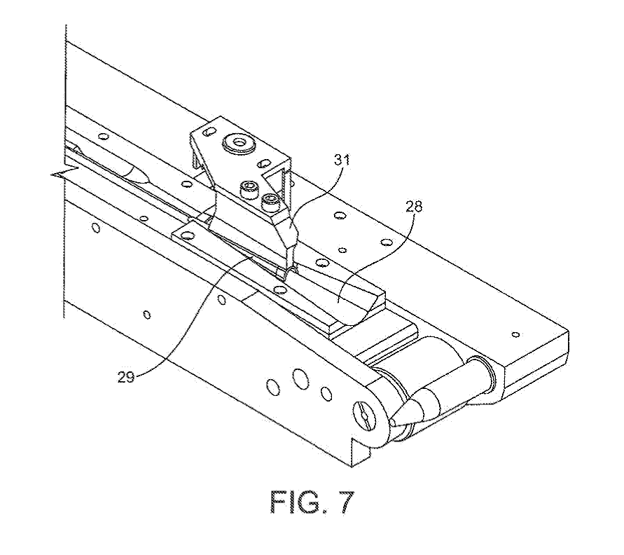

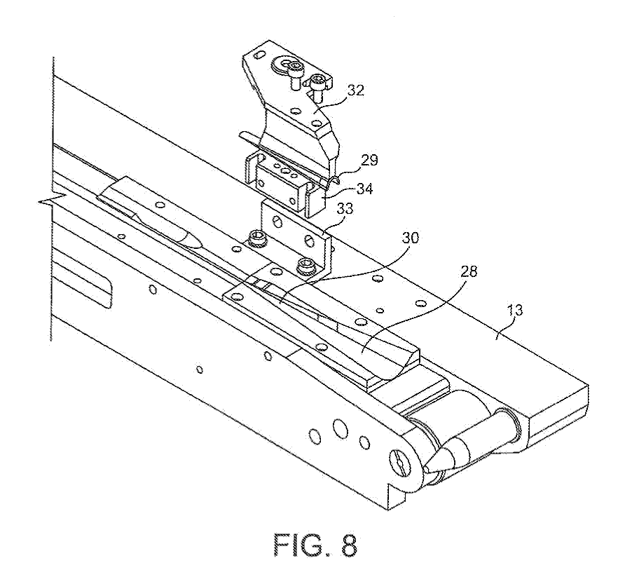

The fixed tongue section 29 is shown in more detail in FIGS. 7 and 8. As shown, the fixed tongue section 29 is formed as a tapered half-pipe, mounted in a tapered channel 30 formed in the lower body 13. In the operative position, channel 28 is integral with channel 30 and the inlet tongue portion 16 is aligned with the inlet of the fixed tongue section 29.

As shown in FIGS. 7 and 8, fixed tongue section 29 is held in place in channel 30 by a mounting assembly 31, which comprises first, second and third mounting brackets 32, 33, 34. As shown, mounting bracket 32 is integrally formed with the top of tongue section 29 and bolted to mounting bracket 34. Mounting bracket 33 is bolted to mounting bracket 34 and to the lower body 13 of the machine 1, thereby fixing the fixed tongue section 29 in position.

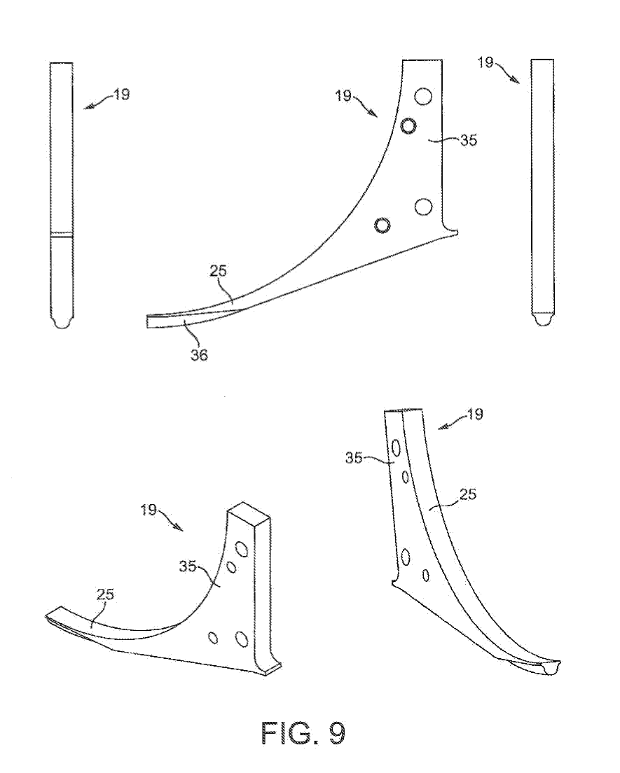

The plough 19 of tongue 4 is shown in more detail in FIG. 9. As shown, the plough 19 has an attachment part 35 and a tow separating edge 36 oppositely disposed to the arcuate surface 25. In operation, tow passing through the tongue 4 comes into contact with tow separating edge 36, which separates the tow into two tow streams on either side of the plough 19. In this way, a furrow is created in the tow, into which capsules are received from the wheel 6. This furrow extends beyond the length of the plough 19, up to a point where the movement of the tow flow causes the furrow to close. During capsule delivery, capsules are carried in the recesses 6a of wheel 6 through the opening 24 and to an exit point, where they exit the wheel and pass through the gap 27 between the plough and shoe and into furrow in the tow. The furrow subsequently closes around the capsules which are carried with the tow through the remainder of the garniture. The paper is subsequently fully wrapped around the tow by the action of the garniture to form an elongate paper wrapped rod, which is subsequently cut to form individual filter rods segments.

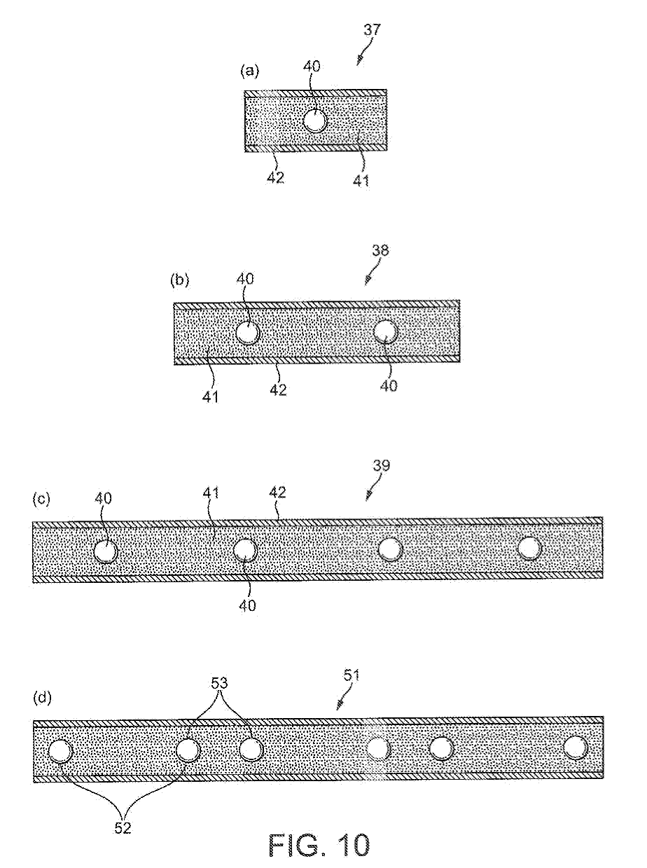

FIG. 10 illustrates different filter rods 37, 38, 39, which may be produced using the machine 1. As shown, each rod includes one or more evenly spaced gelatin capsules 40 surrounded by a plug of cellulose acetate tow 41, the tow being wrapped with a paper wrapper 42. The first, second and third rods 37, 38, 39 respectively comprise one, two and four capsules. The second rod 38 is twice as long as the first rod 37 and the third rod 39 is twice as long as the second rod 38. The skilled person will appreciate that many different rod configuration having different lengths and different numbers of capsules could be produced by the machine 1.

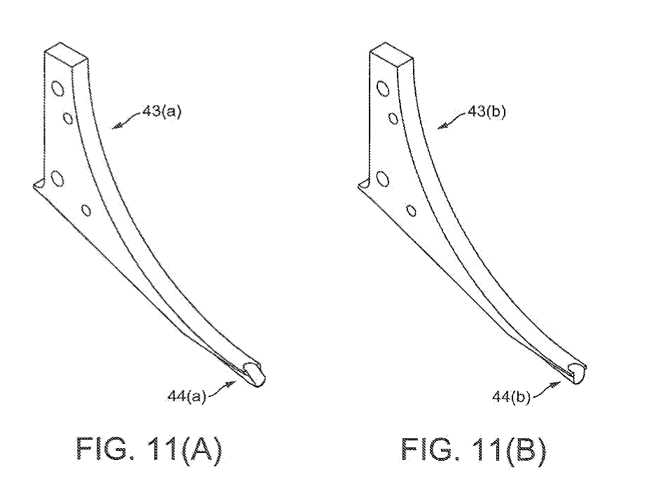

FIG. 11(a) illustrates an alternative plough 43a to the plough 19 which has a capsule guide 44a arranged to receive capsules from the wheel 6 and to guide the capsules into the furrow. The capsule guide 44a assists in positioning the capsules so that once the rod is fully formed, the capsules are axially centred and axially aligned with one another. As shown, the capsule guide 44a is shaped so as to direct the capsules exiting the guide in a direction substantially parallel to the direction of movement of the tow. In this way, impact forces on the capsule are minimised, thus preventing capsule damage. Further, since the capsules do not have a substantial vertical velocity component, vertical deflection due to elastic interaction with the tow is minimised. FIG. 11(b) illustrates a further alternative plough 43(b) having an alternative capsule guide 44(b).

Many other modifications and variations will be evident to those skilled in the art. For example, although the machine 1 has been described as inserting frangible fluid-containing capsules into filter rods, other objects such as pellets, strands, beads or any combination of pellets, strands, beads and capsules could alternatively or in addition be inserted.

Furthermore, the filter rods may be suitable for use in the manufacture of any smoking article, including cigarettes cigars and cigarillos whether based on tobacco, tobacco derivatives, expanded tobacco, reconstituted tobacco or tobacco substitutes and also heat-not-burn products.

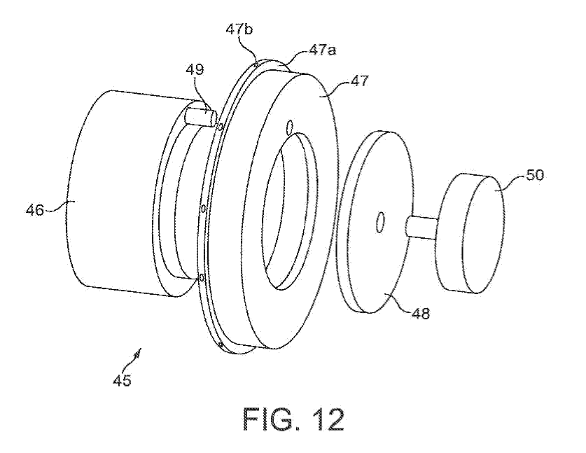

FIG. 12 shows an alternative transport wheel 45. As shown, transport wheel 45 has a front section 46, a delivery drum 47 and a clamp plate 48. As shown a dowel pin 49 connects front section 46 to delivery drum 47. Clamp plate 48 is urged against delivery drum 47 by clamp screw 50, which is bolted to front section 46. The transport wheel 45 can be conveniently disassembled by removing clamp screw 50, thereby allowing easy cleaning of the components. Furthermore, the dowl pin 49 may be used as a marker to identify the angular position of the wheel 45 in relation to the shaft. Thus, before removing the wheel 45 for cleaning, an operator can record the rotational position so that the wheel can be loaded back onto the shaft in the same rotational position after cleaning.

The hopper 10 may include a deflector or roller arranged to carry the weight of some of the capsules in the hopper, so that capsules do not become crushed therein. The hopper 10 may further comprise a vibrating plate to agitate the capsules, to facilitate transfer into the wheel 6. An air jet unit may be mounted in the hopper 10 to assist capsule movement. The wheel 6 may comprise raised notches to further agitate the capsules in the hopper.

Further, although the capsule-receiving recesses are preferably arranged evenly around the circumference of the wheel 6, 45 so that an even separation is achieved between capsules in the elongate filter rod, alternatively the capsule-receiving recesses may be arranged according to a different pattern to provide different spacings between different capsule pairs in the elongate filter rod.

For example, the capsule-receiving recesses 6a may be arranged so that the separation between a first pair of capsules is 24 mm while the separation between a neighbouring pair of capsules is 12 mm. A filter rod 51 produced by a machine having capsule-receiving recess arranged in this way is illustrated in FIG. 10(d). The separation between capsules in capsule pair 52 is 24 mm and the separation between capsules in neighbouring capsule pair 53 is 12 mm. The filter rod 51 is 108 mm long. The separation between the edge of the rod 51 and the first capsule is 6 mm.

Many other modifications and variations will be evident to those skilled in the art, that fall within the scope of the following claims:

1. A machine for making filter rods for use in the manufacture of smoking articles, comprising:
a garniture configured to receive filter plug material and filter wrapping material and to form a wrapped elongate filter rod, the garniture comprising a tongue configured so that filter plug material is compressed as it passes through the tongue;
a rotatable object-transport member arranged to deliver objects directly into the tongue such that the objects are inserted into filter plug material passing through the tongue; and
a cutter configured to cut the elongate filter rod, thereby forming filter rod segments, each segment having one or more objects therein.

2. The machine according to claim 1, wherein the rotatable object-transport member penetrates into the tongue such that each said object exits the object-transport member at an exit point inside the tongue.

3. The machine according to claim 1, further comprising a plough configured to open a furrow in the filter plug material passing through the tongue, wherein the objects are inserted into said furrow.

4. The machine according to claim 3, wherein the plough comprises a guide member arranged to guide objects from the rotatable object-transport member into the furrow.

5. The machine according to claim 1, further comprising a stuffer jet configured to compress tow before the tow enters the garniture.

6. The machine according to claim 1, further comprising:
a first body part comprising a first tongue part;
a second body part comprising said object-transport member and a second tongue part; and
a hinge arranged so that the relative position of the first and second body parts can be adjusted between a first position in which the first and second tongue parts are separated so that the interior of the tongue is accessible for cleaning and tow threading and a second position in which the first and second tongue parts are aligned so that tow can pass from one to the other.

7. The machine according to claim 6, wherein the first body part is an upper body part and the second body part is a lower body part and wherein the upper body part rests on the lower body part in the second position.

8. The machine according to claim 7, further comprising a positioning mechanism configured to selectively raise and lower the upper body part relative to the lower body part, thereby adjusting the relative position of the upper and lower body parts between the first and second positions.

9. A machine for making filter rods for use in the manufacture of smoking articles, comprising:
a garniture configured to receive filter plug material and filter wrapping material and to form a wrapped elongate filter rod, the garniture comp, 9rising a tongue having first and second parts;
a rotatable object-transport member arranged to receive objects from an object store and to insert said objects into the filter rods;
a cutter configured to cut the elongate filter rod, thereby forming filter rod segments, each segment having one or more objects therein;
wherein a filter rod maker has:
a first body part comprising said first tongue part;
a second body part comprising said object-transport member and said second tongue part; and
a hinge arranged so that the relative position of the first and second body parts can be adjusted between a first position in which the first and second tongue parts are separated so that the interior of the tongue is accessible for cleaning and tow threading and a second position in which the first and second tongue parts are aligned so that tow can pass from one to the other.

10. The machine according to claim 1, wherein the objects are frangible, fluid-containing capsules.

11. A garniture tongue of a machine for making filter rods for use in the manufacture of smoking articles, the garniture tongue having an inlet for filter plug material and an opening adapted to receive a rotatable object-transport member so that objects may be received into the tongue directly from the rotatable object-transport member, wherein the garniture tongue is configured so that filter plug material is compressed as it passes through the tongue.

12. The garniture tongue as claimed in claim 11, further comprising a plough configured to open a furrow in filter plug material passing through the tongue so that objects may be inserted into the furrow.

13. The garniture tongue as claimed in claim 12, wherein the plough comprises a guide member arranged to guide objects from the rotatable object-transport member into the furrow

14. (canceled)

15. A method of making filter rods for use in the manufacture of smoking articles, comprising:
receiving filter plug material and filter wrapping material;
drawing the filter plug material through a tongue of a garniture of a filter rod making machine;
compressing the filter plug material as it passes through the garniture tongue;
delivering objects from a rotatable object transport member directly into the garniture tongue such that the objects are inserted into filter plug material passing through the tongue;
forming a wrapped elongate filter rod;
cutting the elongate filter rod into filter rod segments, each segment having one or more objects therein.

16. The method according to claim 15, further comprising opening a furrow in the filter plug material passing through the tongue, wherein the objects are inserted into the furrow.

17. The method according to claim 16, further comprising guiding the objects from the rotatable object-transport member into the furrow, wherein optionally, guiding the objects comprises guiding the objects into the furrow in a direction substantially parallel to the direction of movement of the filter plug material passing through the tongue.

18-21. (canceled)

22. The machine according to claim 4 wherein the guide member is configured to guide the objects into the furrow in a direction substantially parallel to the direction of movement of filter plug material passing through the tongue.

23. The garniture tongue as claimed in claim 13, wherein the guide member is configured to guide objects into the furrow in a direction substantially parallel to the direction of movement of filter plug material passing through the tongue.

24. The method according to claim 17 wherein guiding the objects comprises guiding the objects into the furrow in a direction substantially parallel to the direction of movement of the filter plug material passing through the tongue.
